(19) United States
(12) Patent Application Publication
(10) Pub. No.: US 2013/0094238 A1
(43) Pub. Date: Apr. 18, 2013

(54) LED TUBULAR LAMP

(71) Applicants: CHEN-LUNG HUANG, TAINAN CITY (TW); CHUAN-PAN HUANG, TAINAN CITY (TW)

(72) Inventors: CHEN-LUNG HUANG, TAINAN CITY (TW); CHUAN-PAN HUANG, TAINAN CITY (TW)

(21) Appl. No.: 13/273,615

(22) Filed: Oct. 14, 2011

(51) Int. Cl. F21V 1/00; F21V 29/00

(52) U.S. Cl. 362/555

(57) ABSTRACT

An LED tubular lamp includes a shell, a base plate and a lamp shade. The shell is made of one or more shell sections respectively possessing two or more convection holes to carry out ventilation. The shell section has two placing grooves for depositing the base plate and two combining grooves for combining with the lamp shade. The base plate has two sides fitting in the two placing grooves and an upper surface coated with a heat conducting paint, loaded with the LEDs as a light source. So the heat may be absorbed by the heat conducting paint and transmitted through the convection holes into the air. The lamp shade made integral has two combining members to combine with the combining grooves of the shell. The light of the LEDs shines through the lamp shade. The lamp disperses the heat quickly to prolong the service life of the LEDs.

### BACKGROUND OF THE INVENTION

1. Field of the Invention

This invention relates to an LED tubular lamp, particularly to one taking advantage of two or more convection holes in a shell to carry out ventilation and a layer of heat conducting paint to absorb heat generated by LEDs and then disperse it by radiation.

2. Description of the Prior Art

Commonly, as shown in FIGS. 1 and 2, a first conventional LED tubular lamp 1 is composed of a shell 10, a base plate 11 and a shade 12. The shell 10 is made of aluminum via integral extrusion molding. The shade 12 is usually made of plastics via injection molding. However, the heat generated by plural LEDs deposited on the base plate 11 can only be conducted through a heat conducting elastomer coated on the base plate 21 to the shell 10 for a further heat dispersing, with a low heat dispersing efficiency so that the heat generated by the LEDs cannot scatter out timely. As the LEDs always stay in a high temperature environment, they may quickly break down, unable to have an expected long-term service. Moreover, as the shell 10 is made of metal, it may be too heavy and easily fall down.

Next, FIGS. 3 and 4 show a second conventional LED tubular lamp, which is also composed of a shell 20, a base plate 21 and a shade 22. The shell 20 and the shade 22 are made of plastics via integral extrusion molding, with different colors and shapes. The sole advantage is that the weight is light. But, it is very inconvenient that the base plate 21 is positioned between the shell 20 and the shade 22 forming an airtight space. Moreover, as the heat generated by the LEDs can only be absorbed and dispersed by the shell 20, with a heat dispersing efficiency even lower than that of the first conventional one mentioned previously, it also cannot be scattered out timely to enable the LEDs to serve for a long time as expected.

### SUMMARY OF THE INVENTION

The object of this invention is to offer an LED tubular lamp dispersing heat by two ways, so that heat generated by the LEDs can be swiftly scattered out, not only lengthening service life of the LEDs to make the LED lamp more popular, but also saving energy to lower carbon emission.

The main characteristics of the invention are a shell, a base plate and a lamp shade.

The shell is made of plastics or metal, composed of one or more shell sections.

The plural shell sections are respectively provided with two or more convection holes to create ventilation for quickly dispersing heat.

The base plate has an upper surface coated with a layer of heat conducting paint to absorb the high heat generated by LEDs and disperse it by radiation.

The LED tubular lamp is characterized by taking advantage of the convection holes of the shell to carry out ventilation and the layer of heat conducting paint to disperse heat by radiation, so that heat generated by the LEDs can be quickly scattered out of the tubular lamp to prolong service life of the LEDs.

### BRIEF DESCRIPTION OF DRAWINGS

This invention is better understood by referring to the accompanying drawings, wherein:

FIG. 1 is a side view of a first conventional LED tubular lamp;

FIG. 2 is a cross-sectional view of a “A-A” line in FIG. 1;

FIG. 3 is a side view of a second conventional LED tubular lamp;

FIG. 4 is a cross-sectional view of a “B-B” line in FIG. 3;

FIG. 5 is an exploded perspective view of a first preferred embodiment of an LED tubular lamp in the present invention;

FIG. 6 is a side view of a shell of the first preferred embodiment of an LED tubular lamp in the present invention;

FIG. 7 is a cross-sectional view of a “C-C” line in FIG. 6;

FIG. 8 is a side view of the first preferred embodiment of an LED tubular lamp in the present invention;

FIG. 9 is a cross-sectional view of a “D-D” line in FIG. 8;

FIG. 10 is a side view of the first preferred embodiment of an LED tubular lamp in the present invention;

FIG. 11 is a cross-sectional view of an “E-E” line in FIG. 10;

FIG. 12 is a side view of a second preferred embodiment of an LED tubular lamp in the present invention;

FIG. 13 is a side view of a third preferred embodiment of an LED tubular lamp in the present invention; and

FIG. 14 is a side view of a fourth preferred embodiment of an LED tubular lamp in the present invention.

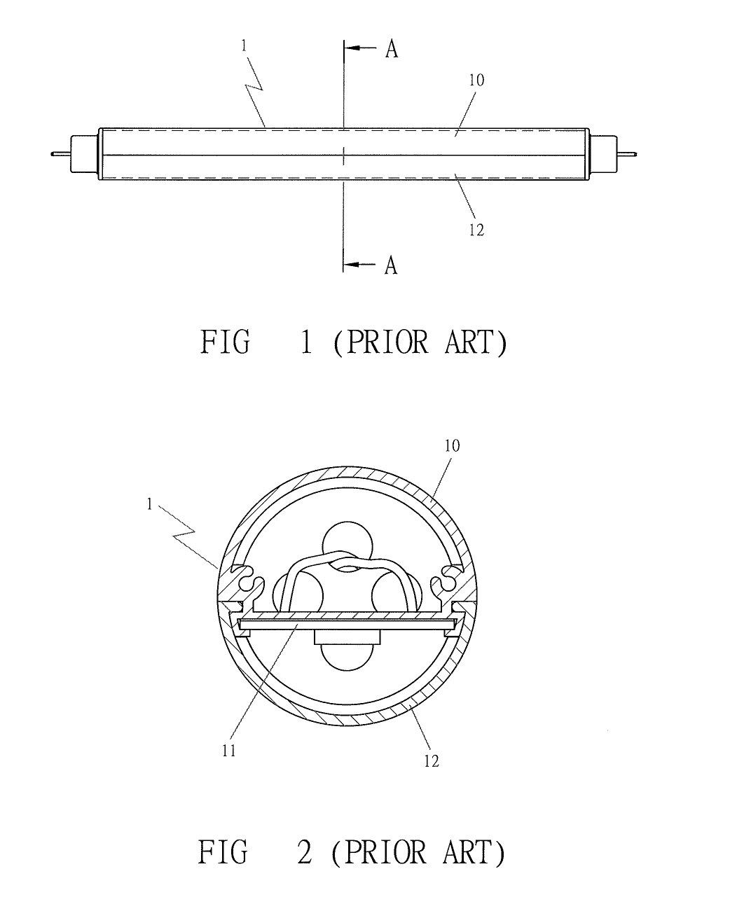

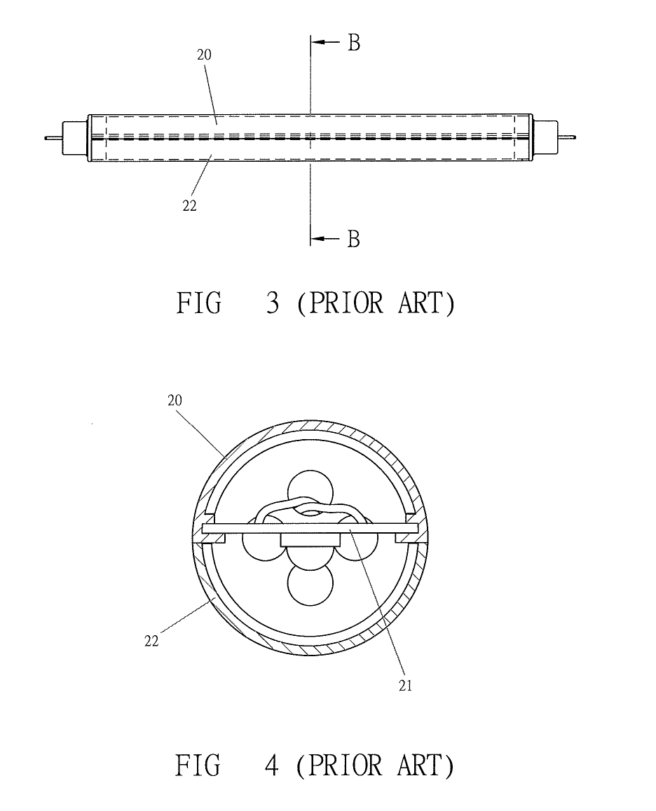

### DETAILED DESCRIPTION OF THE PREFERRED EMBODIMENT

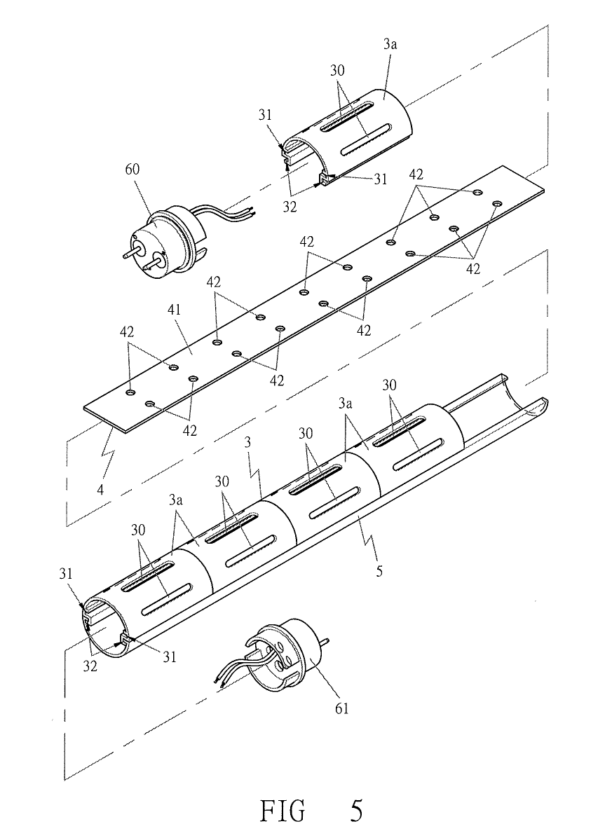

As shown in FIGS. 5˜11, a first preferred embodiment of an LED tubular lamp in the present invention at least includes a shell 3, a base plate 4 and a lamp shade 5.

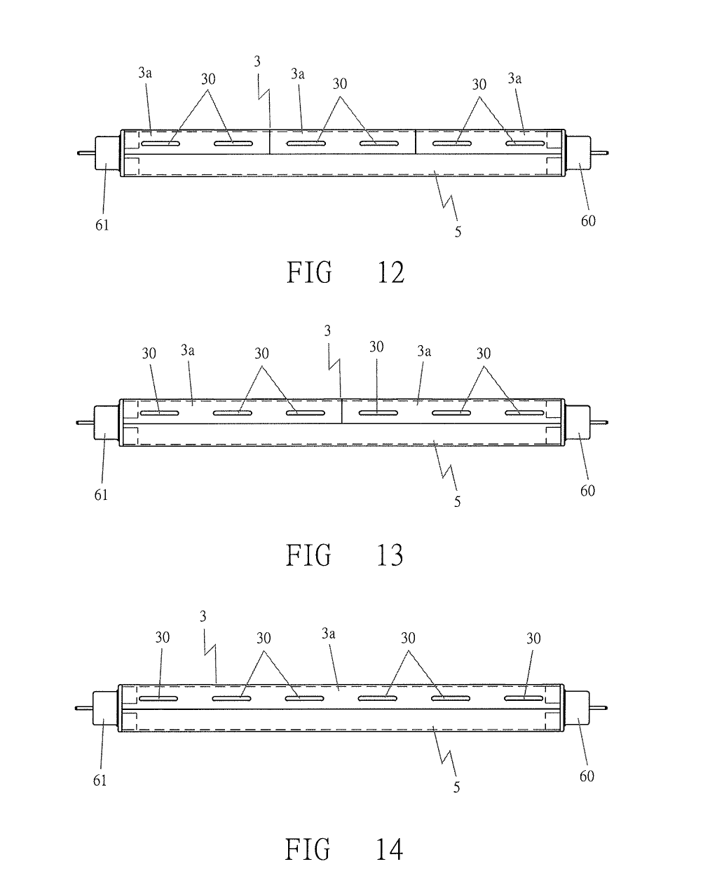

The shell 3 consists of one or more shell sections 3a, which are made of plastics or metal. A fourth embodiment of the invention has a single shell section 3a, as shown in FIG. 14. FIGS. 10, 12 and 13, respectively showing the first embodiment, a second embodiment and a third embodiment of the invention, are composed of more than one shell section 3a. For the shell 3 with more than one shell section 3a, the shell sections 3a are one by one combined with the lamp shade 5 orderly. If necessary, the plural shell sections 3a can be further glued together as a single shell 3, as shown in FIGS. 5, 10, 12 and 13.

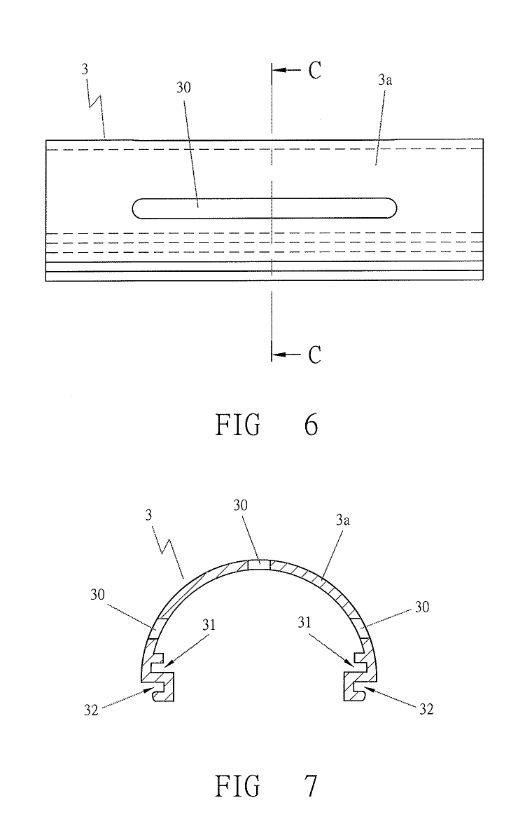

As shown in FIGS. 6 and 7, each shell section 3a is provided with two or more convection holes 30 depending on necessity, with the convection hole 30 bored in the top of the shell section 3a to let heated air flow out so that the convection holes 30 bored in two sides of the shell section 3a can suck room-temperature air outside the lamp into a space 33 surrounded by the shell 3 and the base plate 4, making air ventilated to swiftly disperse high heat generated by LEDs 40. The way to design the convection holes 30 is not limited in FIGS. 6 and 7.

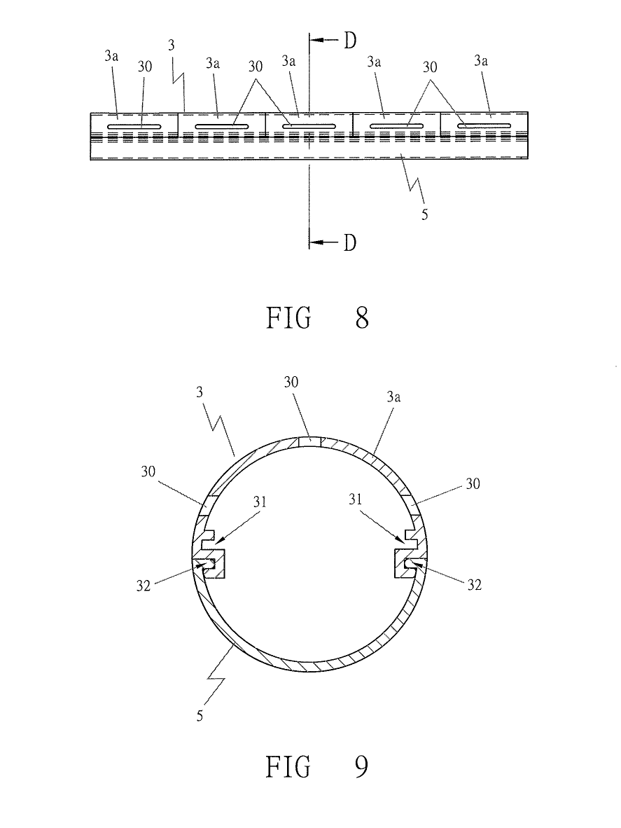

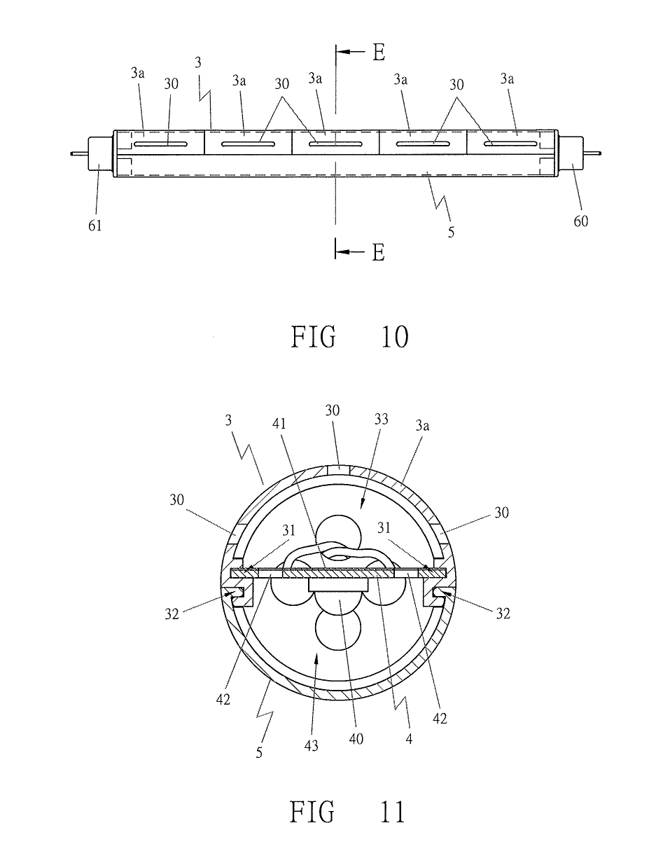

The shell section 3a is further provided with two placing grooves 31 symmetrically located on an inner wall for depositing the base plate 4, as shown in FIGS. 10 and 11, and with two combining grooves 32 symmetrically located on a lower side of an outer surface for depositing the lamp shade 5, as shown in FIGS. 8 and 9.

The base plate 4 is deposited in the placing grooves 31, provided with plural LEDs 40 used as a light source, as shown in FIGS. 10 and 11. Coated on an upper surface of the base plate 4 is a layer of heat conducting paint 41 employed to absorb some of the heat generated by the LEDs 40 and disperse it via radiation. Then by means of the convection holes 30 of the shell 3 to carry out ventilation, the heat can be quickly brought out of the tubular lamp. In addition, the base plate 4 is also provided with one or more vents 42, which can let heat generated by the LEDs 40 dispersed in a space 43 surrounded by the base plate 4 and the lamp shade 5 and then flow into the space 33 so as to flow out through the convection holes 30 of the shell 3 into the air, advantageous for further exhaust of the high heat.

The lamp shade 5 is integrally made of plastics, provided with a combining member 50 respectively at two lengthwise sides to combine with the two combining grooves 32 of the shell 3, as shown in FIGS. 8˜11. So the light produced by the LEDs 40 may shine out through the lamp shade 5.

In assembly, the shell sections 3a of the shell 3 are first combined with the lamp shade 5. Next the base plate 4 is inserted through the placing grooves 31 of the shell 3 and positioned between the shell 3 and the lamp shade 5. Finally two electric connectors 60 and 61 (not included in the invention) have to be respectively installed at two sides of the tubular lamp of the invention. So a brand-new tubular lamp of the invention is finished.

The advantages of the invention are described as can be seen from the foresaid description. With the heat conducting paint 41 coated on the base plate 4 to swiftly absorb and disperse heat, and with the convection holes 30 of the shell 3 to create a good ventilation, the high heat generated by the LEDs 40 in the shell 3 and the lamp shade 5 can be efficiently scattered out into the air, not only maintaining the service life of the LEDs as long as expected, but also saving energy to lower carbon emission.

While the preferred embodiment of the invention has been described above, it will be recognized and understood that various modifications may be made therein and the appended claims are intended to cover all such modifications that may fall within the spirit and scope of the invention.

What is claimed is:

1. A LED tubular lamp at least comprising:
a shell consisting of one or more shell sections, said shell section provided with two or more convection holes to carry out ventilation for dispersing high heat generated by LEDs, said shell section further provided with two placing grooves symmetrically located on an inner wall for depositing a base plate and with two combining grooves symmetrically located on a lower side of an outer surface for depositing a lamp shade;
said base plate deposited in said placing grooves and provided with plural LEDs as a light source, a layer of heat conducting paint coated on said base plate to absorb and disperse some of the heat generated by said LEDs so that the heat can be swiftly scattered out into the air via ventilation of said convection holes of said shell;
said lamp shade provided with a combining member respectively at two lengthwise sides to combine with said combining grooves of the shell and employed to let light produced by said LEDs shine out through it; and
characterized by taking advantage of said convection holes of said shell to carry out ventilation and said heat conducting paint coated on said base plate to absorb heat and disperse it by radiation so that heat generated by said LEDs can be quickly scattered out of said tubular lamp to prolong service life of said LEDs.

2. The LED tubular lamp as claimed in claim 1, wherein said shell is made of plastics.

3. The LED tubular lamp as claimed in claim 1, wherein said shell is made of metal.

4. The LED tubular lamp as claimed in claim 1, wherein said shell is composed of one shell section.

5. The LED tubular lamp as claimed in claim 1, wherein said shell is composed of more than one shell section.

6. The LED tubular lamp as claimed in claim 5, wherein said shell sections are combined with said lamp shade one by one.

7. The LED tubular lamp as claimed in claim 6, wherein said shell sections are further glued together.

8. The LED tubular lamp as claimed in claim 1, wherein said shell section is further provided with two or more convection holes depending on necessity, with said convection holes bored in two sides of said shell section to let room temperature air flow into said shell and with said convection hole bored in a top of said shell section to let heated air flow out so as to carry out ventilation.

9. The LED tubular lamp as claimed in claim 1, wherein said base plate is further provided with one or more vents which can enable high heat dispersed in a space surrounded by said base plate and said lamp shade to flow into a space surrounded by said shell and said base plate and then to flow out through said convection holes of said shell into the air.

10. A LED tubular lamp at least comprising:
a shell consisting of one or more shell sections, said shell section provided with two or more convection holes to carry out ventilation for dispersing high heat generated by LEDs, said shell section further provided with two placing grooves symmetrically located on an inner wall for depositing a base plate and with two combining grooves symmetrically located on a lower side of an outer surface for depositing a lamp shade;
said base plate deposited in said placing grooves and provided with plural LEDs as a light source;
said lamp shade provided with a combining member respectively at two lengthwise sides to combine with said combining grooves of said shell and employed to let light produced by said LEDs shine out through it; and
characterized by taking advantage of said convection holes of said shell to carry out ventilation so that heat generated by said LEDs can be quickly scattered out of said tubular lamp to prolong service life of said LEDs.

11. The LED tubular lamp as claimed in claim 10, wherein said shell is composed of one shell section.

12. The LED tubular lamp as claimed in claim 10, wherein said shell is composed of more than one shell section.

13. The LED tubular lamp as claimed in claim 12, wherein said shell sections are combined with said lamp shade one by one.

14. The LED tubular lamp as claimed in claim 6, wherein said shell sections are further glued together.

15. The LED tubular lamp as claimed in claim 10, wherein said shell section is further provided with two or more convection holes depending on necessity, with said convection holes bored in two sides of said shell section to let room temperature air flow into said shell and with said convection hole bored in a top of said shell section to let heated air flow out so as to carry out ventilation.

16. The LED tubular lamp as claimed in claim 10, wherein said base plate is further provided with one or more vents which can enable high heat dispersed in a space surrounded by said base plate and said lamp shade to flow into a space surrounded by said shell and said base plate and then to flow out through said convection holes of said shell into the air.

17. A LED tubular lamp at least comprising:
a shell consisting of more than one shell section which is provided with two combining grooves symmetrically located on a lower side of an outer surface for depositing a lamp shade;
a base plate deposited in two placing grooves symmetrically located on an inner wall of said shell and provided with plural LEDs as a light source;
said lamp shade provided with a combining member respectively at two lengthwise sides to combine with said combining grooves of said shell and employed to let light produced by said LEDs shine out through it; and
characterized by said shell composed of a single shell section to achieve a quick assembly.
